(19) United States
(12) Patent Application Publication
(10) Pub. No.: US 2013/0129423 A1
(43) Pub. Date: May 23, 2013

(54) METHOD AND ARRANGEMENT FOR PREVENTING MOVEMENT OF STRUCTURE

(71) Applicants: Sami Häkkinen, Tampere (FI); Tuomas Lievonen, Nokia (FI)

(72) Inventors: Sami Häkkinen, Tampere (FI); Tuomas Lievonen, Nokia (FI)

(73) Assignee: URETEK WORLDWIDE OY, Pirkkala (FI)

(21) Appl. No.: 13/642,495

(22) PCT Filed: Apr. 18, 2011
(86) PCT No.: PCT/FI2011/050344

§ 371 Date: Jan. 3, 2013

(30) Foreign Application Priority Data
Apr. 19, 2010 (FI) FI 20105414

(51) Int. Cl. E21D 20/02; B09C 1/08

(52) U.S. Cl. CPC E21D 20/028; B09C 1/08
USPC 405/128.7; 405/259.5

(57) ABSTRACT

The invention relates to a method and arrangement for preventing movement of a structure. An expansion element (6) is arranged in soil. A material which expands inside the expansion element (6) as a consequence of a chemical reaction is injected into the expansion element (6). The expanded expansion element (6) remains in its place in the soil owing to friction and cohesive forces, and it is fastened to the structure (2), the expansion element (6) thus preventing movement of the structure (2).

### BACKGROUND OF THE INVENTION

The invention relates to a method of preventing movement of a structure.

The invention further relates to an arrangement for preventing movement of a structure.

Typically, an attempt at preventing movement of structures, such as foundations of buildings, is made by ensuring that the soil beneath the structure does not allow the structure to move. In order to improve the soil, for instance, soil having a poor load-bearing capacity is replaced by a material having a better load-bearing capacity. Such a technique, so-called mass replacement, is extremely laborious and expensive. Further, piling techniques, such as friction piles, are used that by means of friction are supported by the soil, or bottom piles that rest on a hard bottom layer. JP 59 130 910 discloses a solution wherein an attempt is made at improving the load-bearing capacity of a railway line by inserting, through a railway embankment and a roadbed, friction piles into the soil beneath the roadbed.

It is typical of the above-described solutions that they have to be carried out prior to constructing a building, since said solutions are very difficult and laborious to implement for existing buildings.

EP 0 851 064 and EP 1 314 824 disclose a solution for improving the load-bearing capacity of soil. In the solutions, holes are drilled into the soil and a material which expands as a consequence of a chemical reaction is injected into a hole. Under extremely difficult conditions, this becomes a task that requires skill and knowhow in order to achieve a good end result.

### BRIEF DESCRIPTION OF THE INVENTION

An object of the present invention is to provide a novel method and arrangement for preventing movement of a structure.

A method according to the invention is characterized by arranging an expansion element in soil, injecting into the expansion element a material which expands inside the expansion element as a consequence of a chemical reaction, whereby the expanded expansion element remains in its place in the soil owing to friction and cohesive forces, and fastening the expansion element to the structure, the expansion element thus preventing movement of the structure.

An arrangement according to the invention is characterized in that the arrangement comprises an expansion element arranged in soil, a material injected into the expansion element, the material expanding as a consequence of a chemical reaction such that the expansion element remains in its place in the soil owing to friction and cohesive forces, and fastening means for fastening the expansion element to the structure.

An idea underlying the invention is that an expansion element is arranged in the soil. A material which expands as a consequence of a chemical reaction is injected into the expansion element. The expanded expansion element remains in its place in the soil owing to friction and cohesive forces, and it is fastened to a structure, in which case the expansion element is used for preventing movement of the structure. It is also possible to use the disclosed solution e.g. in difficult soil conditions, e.g. for preventing movement of foundations of buildings that are built on soil containing reactive clay or that reside in a loose soil on a slope. Particularly well the solution is suited for use to prevent or reduce damages caused by earthquakes and related soil liquefaction to structures and buildings. The material injected into the expansion element is such that it solidifies quite quickly, so the solution necessitates e.g. no valves to keep the material inside the expansion element. No high pressure is needed to inject the injectable material, so all in all the machines and devices used in the solution are quite small and simple and, furthermore, the solution is excellent in terms of work safety. The means used for conveying the material e.g. through an injection bar into the expansion element may be quite simple and lightweight, because they do not have to generate any pressure that would expand the expansion element inside the soil. The means generate pressure which enables the injectable material to be inserted into the expansion element e.g. through hoses and tubes, but the means themselves generate no expansion pressure but the expansion pressure is generated inside the expansion element chemically.

### BRIEF DESCRIPTION OF THE FIGURES

The invention is described in closer detail in the accompanying drawings, in which

FIG. 1 schematically shows a solution for preventing movement of structures of a building located on reactive clay,

FIG. 2 schematically shows a solution for preventing movement of structures of a building located on a slope,

FIG. 3 is a schematic cross-sectional side view showing an injection bar and an expansion element,

FIG. 4 shows the solution according to FIG. 3 in a situation wherein a chemically reacting material has been injected into the expansion element,

FIG. 5 schematically shows a third solution for preventing movement of a structure, and

FIG. 6 schematically shows a fourth solution for preventing movement of a structure.

For the sake of clarity, the figures show some embodiments of the invention in a simplified manner. Like reference numerals identify like elements.

### DETAILED DESCRIPTION OF THE INVENTION

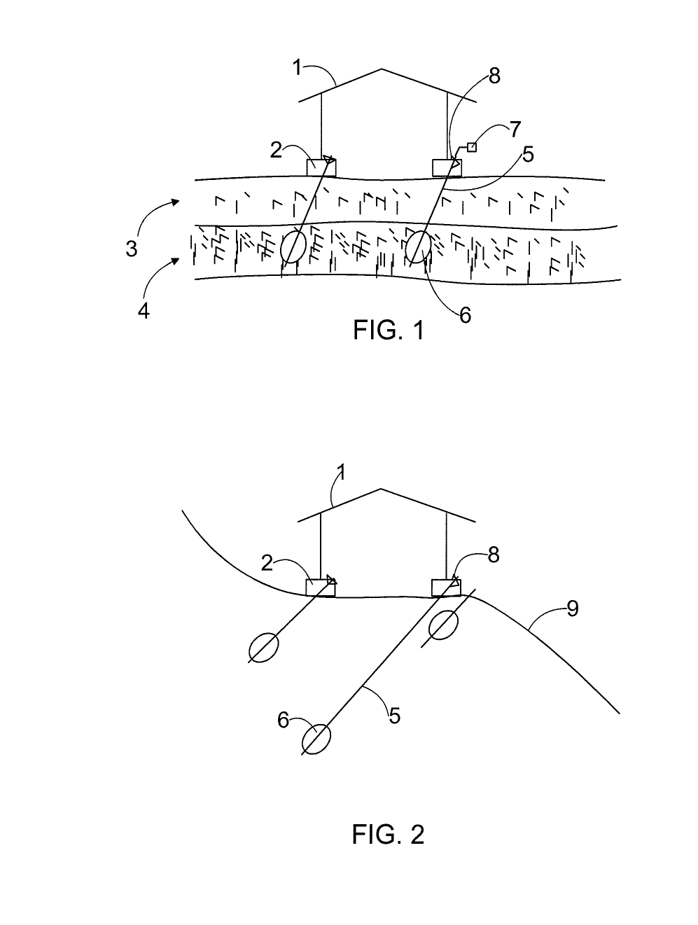

FIG. 1 shows a situation wherein a structure 2, which in the case of FIG. 1 is a substructure or foundations of a house, is located on unstable soil. The unstable soil may contain e.g. a first soil layer 3, which is a dry crust layer of hard clay. Therebeneath resides a second soil layer 4, which may consist of loose clay, for instance. The first soil layer 3 mainly consists of reactive clay, which means that said material reacts strongly e.g. to variations in moisture. For instance, when the soil layer gets wet e.g. in the rain, it expands. Upon drying, again, the soil layer contracts. Consequently, the structure in such a soil tries to move upwards after the rain, which may cause even considerable damage to the building.

Movement of the structure has been prevented by arranging, through the foundations, an injection bar 5 having an expansion element 6 provided in connection therewith. An injection apparatus 7 is used for injecting into the expansion element 6 a material which expands as a consequence of a chemical reaction. Upon reacting, the material fills the expansion element 6. FIG. 1 shows the injection apparatus 7 only referentially. The injection apparatus 7 includes containers wherein the material to be injected into the expansion element 6 is stored, and means for conveying the material from such a container into the injection bar 5. The means may be quite simple and lightweight since they do not have to generate any pressure that would expand the expansion element 6 inside the soil. The means generate pressure which enables the injectable material to be inserted into the expansion element 6 through hoses and tubes, but the means themselves generate no expansion pressure but the expansion pressure is generated inside the expansion element 6 chemically. In this context, the injection apparatus 7 is not discussed in any closer detail since its structure and operation are obvious to those skilled in the art.

The injection bar 5 is fastened to the foundations e.g. by a fastener 8. The injection bar 5 may be fastened to the foundations also e.g. with mortar or soldering material or by another appropriate fastening means.

The expansion element 6 is arranged through the first soil layer 3 e.g. all the way to the second soil layer 4. The expansion element 6 remains in its place owing to friction and cohesive forces in the soil. When the injection bar 5 is further fastened to the foundations, the expansion element 6 and the injection bar 5 prevent or at least reduce movement of the foundations e.g. when the first soil layer 3 tries to move the structure.

The embodiment of FIG. 1 is also suitable for use in situations other than those wherein the soil layers contain reactive clay. The solution may be used e.g. in earthquake areas. In such a case, the solution aims at keeping a building as immobile as possible during and after an earthquake so that no damage is caused to the building by the earthquake or the related liquefaction, or at least so that the damages are small enough to enable the people in the building to be protected against injuries as well as possible. The expansion element 6 may also be used for improving the soil, enabling liquefaction of the soil to be eliminated or reduced. An earthquake tends to move a building up and down in a cyclical motion at a certain frequency. When the expansion element 6 is arranged firmly in the soil and it is by means of the injection bar 5 fastened to the structure, the solution prevents the structure from moving upwards and, moreover, it prevents the structure from moving downwards as well. Most preferably, in such a solution, the injection bar 5 and the expansion element 6 are arranged directly downwards from the structure, contrary to what is shown in FIG. 1.

Furthermore, the solution is suitable for use in all types of situations wherein a structure is subjected to forces trying to move it. Such situations may be caused e.g. by a change in the volume of the soil or by dynamic loads caused by traffic or by other corresponding reasons.

In the case shown in FIG. 2, a house 1 is located on a slope 9 which consists of soil susceptible to erosion. In the worst case, downwards movement of the soil of the slope could even destroy the building thereon. In the case of FIG. 2, this problem is alleviated by arranging beneath the foundations an expansion element 6 filled with a material which expands as a consequence of a chemical reaction. In addition, movement of the foundations is prevented by arranging therethrough in the soil a hole into which an injection bar 5 is inserted and the expansion element 6 arranged in connection therewith in a manner similar to that used in the case shown in FIG. 1.

The inner diameter of the injection bar 5 has to be so small that the material which expands as a consequence of a chemical reaction does not react until inside the expansion element 6 rather than while still inside the injection bar 5. Thus, the inner diameter of the injection bar 5 may be e.g. 3 to 40 mm. Preferably, the inner diameter of the injection bar 5 is less than 30 mm.

The injection bar 5 may be made e.g. from metal, such as steel. The injection bar 5 may also be made from another material, such as plastic, e.g. polyethylene PE. If the injection bar 5 does not have to withstand any other stress than tensile stress, it does not necessarily have to be rigid. In such a case, the injection bar 5 may thus be e.g. a hose or a tube made from plastic. Preferably, however, the injection bar 5 is so rigid that it also withstands, unbending, compression stress applied thereto. Preferably, the thickness of a wall of the injection bar 5 is in the order of 2 to 10 mm when the bar is made from steel.

FIG. 2 shows an injection rod or injection bar 5. An expansion element 6 to be filled is arranged around the injection bar 5. Preferably, the expansion element 6 is made from a substantially inductile material impermeable to air. An example of such a material is geotextile. Further, another flexible and strong material may be used.

The material of the expansion element may be a plastic, such as polyester or polypropylene, or a synthetic or natural fibre. The material may also be rubber or another elastomer. The wall of the expansion element may be permeable to air or impermeable to air. The wall of the expansion element 6 may also be elastic or unelastic. The wall of the expansion element 6 may also be provided with a metallic reinforcement material or glass fibre or another appropriate reinforcement. The expansion element may be seamless or it may have seams. A seam may be made e.g. by sewing, gluing, employing a fastening element, riveting, welding, soldering, fusing or by employing another mechanical, chemical, thermotechnical or electrotechnical method or a combination thereof. The wall of the expansion element 6 may also be such that it allows a portion of the material injected into the expansion element 6 to penetrate through the wall and out of the element.

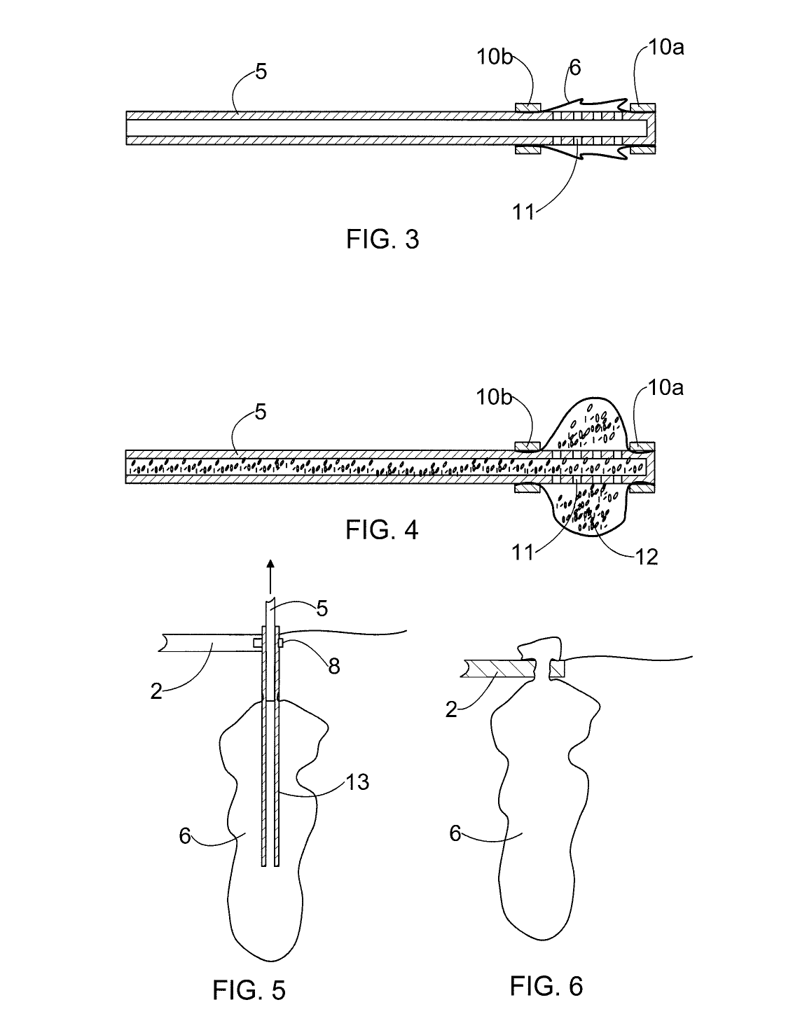

The thickness of the wall of the expansion element 6 may vary e.g. between 0.02 and 5 mm, depending on the material, the size of the expansion element 6, the expansion pressure, etc. Preferably, the injection bar 5 is arranged through the expansion element 6, whereby the expansion element 6 is fastened to the injection bar 5 e.g. in a manner shown in FIG. 3 by a front fastener 10a and a rear fastener 10b.

The material injected into the expansion element 6 is such that it sticks to the injection bar 5. Thus, the expansion element 6 remains fastened to the injection bar 5 owing to both the fasteners 10a and 10b and the material injected into the expansion element 6.

Prior to arranging the injection bar 5 in the soil, the expansion element 6 is wound or folded against the injection bar 5. When the expansion element 6 is filled up with a solid material, its outer diameter may vary e.g. between 20 cm and 5 m. Similarly, the length of the expansion element 6, i.e. a distance between the front fastener 10a and the rear fastener 10b, may vary e.g. between 20 cm and 100 m.

The expansion element 6 may have the shape of e.g. a cylindrical sleeve. Further, the expansion element 6 may be narrower in its upper and lower ends and have a larger diameter in its middle. Prior to injecting the material into the expansion element, the external appearance of the expansion element 6 is irrelevant. After the material has reacted inside the expansion element, the expansion element reaches its final external appearance.

The front fastener 10a and the rear fastener 10b may be e.g. hose clamps. Further, said fasteners may be e.g. metal sleeves formed by cutting off a piece of a tube. The metal sleeve may be fastened in place e.g. by pressing.

The front fastener 10a or the rear fastener 10b or both may also be made mobile, in which case, upon the expansion element 6 being filled, they slide into a suitable position. With respect to stationary fasteners, this solution has an advantage that distortion and, consequently, even breakage, of the injection bar may be avoided. For instance, the front fastener may be made mobile by forming a closed bar at a front end of the injection bar and arranging a mobile sleeve thereon. The wall of the expansion element is placed on top of the mobile sleeve and a fastening sleeve is arranged around it, the wall of the expansion element thus residing fixedly between the fastening sleeve and the mobile sleeve. When the mobile sleeve is thus allowed to move along the surface of the bar, the fastener moves as the expansion element is being filled up.

The injectable material flows through the hollow inner part of the injection bar 5 and further through holes 11 provided in a side of the injection bar 5 into the expansion element 6. A chemical reaction takes place in the expansion element 6 such that the material expands inside the expansion element 6.

FIG. 4 shows a situation wherein the injection bar 5 is arranged inside the soil and the material 12 inside the expansion element 6 has reacted, expanding the expansion element 6.

The injectable material may be e.g. a polymer, expanding resin or an organically incrystallizable, chemically expanding multicomponent material.

The injectable material may be e.g. a mixture of mainly two components. In such a case, a first component may contain e.g. mainly poly-ether polyol and/or polyester polyol. A second component may contain e.g. isocyanate. The volumetric ratios of the first and the second components may vary e.g. within a range of 0.8 to 1.2:0.8 to 1.8. The expanding material may further contain catalysts and water and, when desired, also other components, such as silica, rock dust, fibre reinforcement, and other possible additives and/or auxiliaries.

Preferably, the injectable material is such that it starts to react by expanding within 0.5 to 3600 seconds from being injected into the expansion element 6. In an embodiment, the material starts to react after more than 20 or more than 25 seconds from injection, whereby the expansion element 6 is filled up in a uniform manner and a risk of the expansion element 6 being broken is quite small. Further, in an embodiment, the material starts to react within less than 50 seconds from injection, making the process easy to control.

The material expands into a volume of e.g. 1 to 120 times the original one. The expansion factor of the material, i.e. the volume of the material at the end of the reaction as compared to the volume of the material at the beginning of the reaction, may be e.g. in the order of 1.1 to 120. Preferably, the material is arranged to expand to a volume of 1.5 to 20 times its original volume.

The expansion element 6 may thus be e.g. a cylindrical sleeve or another corresponding structure, which is thus determined by a wall made from a flexible material. The injection bar 5 does not necessarily have to go through the expansion element 6 but the expansion element 6 may be e.g. fastened to an end of the injection bar 5. The expansion element 6 may then be e.g. a pouch or a bag. In such a case, the expansion element 6 is thus fastened to the the injection bar 5 only by one point thereof, and the material flows through the hollow injection bar 5 from its end into the expansion element 6.

In order to reduce the size of the hole required by the expansion element 6, it is preferably made to have an outer diameter which is as small as possible. The expansion element is folded outside the injection bar 5 and, preferably, it is made as compact as possible against the injection bar 5 e.g. by a press. The outer diameter of the expansion element may be reduced by utilizing heat, pressurized air, moisture, suction and/or compression by rolling by a rolling wheel, for instance. It may further be ensured that the expansion element 6 remains tightly against the injection bar 5 by arranging a plastic film thereon. The plastic film may be arranged on top of the expansion element 6 e.g. by slipping or winding.

The expansion element 6 does not necessarily have to be arranged outside the injection bar. If the inner diameter of the injection bar 5 is sufficient, the expansion element 6 may be folded inside the injection bar 5. In such cases, the expansion element 6 may be e.g. a pouch or a bag fastened by its mouth part to a tail end of the injection bar 5. Then, when the material is injected into the expansion element 6, the material pushes the expansion element 6 out from inside the injection bar.

FIGS. 5 and 6 illustrate how a variation in the properties of the soil at different points thereof affects the shape of the expansion element 6. The smaller the resistant force met by the expansion element in the soil, the more easily it expands. When, again, the soil is denser, the expansion element meets a greater resistant force and does not necessarily expand to the same extent as elsewhere. Consequently, the expansion element 6 becomes irregular in shape. The irregular shape of the expansion element 6 contributes to keeping the expansion element 6 more immobile in the soil.

FIG. 5 shows a so-called double tube structure. In this structure, the injection bar 5 is arranged inside a fastening bar 13. The fastening bar 13, again, is connected to the expansion element 6 and, e.g. by the fastener 8, to the structure 2.

The injectable material is injected by the injection bar 5 which may be pulled away from inside the fastening bar 13 as shown by an arrow illustrated in FIG. 5. In such a case, movement of the structure 2 is thus prevented by the expansion element 6 connected to the structure by the fastening bar 13. The fastening bar 13 may be so short that it extends only to an upper part of the expansion element 6. During injection, the injection bar 5 may be arranged all the way inside the expansion element 6, whereby during injection, it is lifted from a lower part of the expansion element 6 towards the upper part thereof and, finally, out of the expansion element 6 through the fastening bar 13. The fastening bar 13 may also extend, as illustrated in FIG. 5, inside the expansion element 6. In such a case, preferably, walls of the fastening bar 13 are provided with holes through which the material to be injected from the injection bar 5 is allowed to enter the expansion element 6.

In the embodiment of FIG. 5, no expansion element 6 nor bars 5 and 13 are arranged through the structure 2. Consequently, no hole has to be made in the structure 2. The fastening bar 13 is, then, fastened by the fastener 8 to a side of the structure 2.

In the embodiment of FIG. 6, the expansion element 6 is not fastened to the structure 2 by any bar but the expansion element 6 in itself is fixed to the structure 2. In the embodiment of FIG. 6, the expansion element is arranged partly through the structure 2. The expansion element 6 has been expanded by the expanding material to also extend above the structure 2, enabling the expansion element 6 to be tightly locked in connection with the structure 2. The expansion element 6 may be filled by using an injection bar which is pulled from inside the expansion element 6. The expansion element 6 may also be filled without any injection bar, in which case the material is injected from a nozzle of an injection device directly to the expansion element 6.

In some cases, the features disclosed in the present application may be used as such, irrespective of other features. On the other hand, when necessary, the features set forth in the present application may be combined in order to provide different combinations.

The drawings and the related description are only intended to illustrate the idea of the invention. The details of the invention may vary within the scope of the claims. Thus, instead of foundations of a building, the structure to be held in place may also be another structure which is to remain as immobile as possible in connection with soil.

The expansion element may thus be fastened to the structure either directly or by means of a bar. The bar, again, may be fastened to the structure by fasteners, such as a steel plate, or by providing the outside of the bar with a thread for screwing up a mounting nut or the like. Further, a fastening mass or the like may be injected between the bar and the structure. The fastening may also be implemented such that an expansion element or a part of an expansion element located mainly above the structure is provided on top of the structure. The bar may be fastened to the expansion element 6 such that first an expansion element is arranged in the soil and the injection bar is removed. Next, an injection path is drilled open again and some length of a hole is drilled into the expansion element 6. To this formed hole, the bar may be fastened which, e.g. by using some fastening mass, is fastened to the expansion element. On the other hand, the bar may be a screw which is drilled into the expansion element 6. Further, the expansion element 6 may be fastened to the structure e.g. by a wire. Of course, the wire only enables a pulling effect to be achieved. By its upper end, the expansion element may also be provided with a thread fitting counterpiece for screwing up the fastening bar or the like. Further, a plurality of expansion elements 6 may be arranged in the soil on top of one another such that the expansion elements 6 are connected to one another.

1. A method of preventing movement of a structure, the method comprising
arranging an expansion element in soil,
injecting into the expansion element a material which expands inside the expansion element as a consequence of a chemical reaction, wherein the expanded expansion element remains in place in the soil owing to friction and cohesive forces, and
fastening the expansion element to the structure, the expansion element thus preventing movement of the structure.

2. The method of claim 1, further comprising injecting the material into the expansion element through an injection bar.

3. The method of claim 2, further comprising arranging the material to flow into the expansion element through holes provided in a side of the injection bar.

4. The method of claim 2, comprising fastening the expansion element to the structure by the injection bar.

5. An apparatus for preventing movement of a structure, comprising an expansion element arranged in soil, a material injected into the expansion element, the material expanding as a consequence of a chemical reaction such that the expansion element remains in place in the soil owing to friction and cohesive forces, and fastening element for fastening the expansion element to the structure.

6. The apparatus of claim 5, comprising an injection bar for injecting the material into the expansion element.

7. The apparatus of claim 6, wherein the injection bar is arranged through the expansion element, wherein the expansion element is fastened to the injection bar at a front end by front fasteners and at a rear end by rear fasteners, and that a side of the injection bar is provided with holes enabling the material to flow therethrough into the expansion element.

8. The apparatus of claim 6, wherein an inner diameter of the injection bar is less than 30 mm.

9. The apparatus of claim 5, wherein the expansion element is fastened to the structure by means of the injection bar.

10. The method of claim 3, further comprising fastening the expansion element to the structure via the injection bar.

11. The apparatus of claim 6, wherein an inner diameter of the injection bar is less than 30 mm.

12. The apparatus of claim 6, wherein the expansion element is fastened to the structure via the injection bar.

13. The apparatus of claim 7, wherein the expansion element is fastened to the structure via the injection bar.

14. The apparatus of claim 11, wherein the expansion element is fastened to the structure via the injection bar.

15. A system for preventing movement of a structure, comprising:
means for, expanding material that is arranged in soil;
wherein, the material expands as a consequence of a chemical reaction such that the means for expanding the material remains in place in the soil due to friction and cohesive forces; and
means for, fastening the means for expanding the material to the structure.
